(19) United States
(12) Patent Application Publication
(10) Pub. No.: US 2025/0334678 A1
(43) Pub. Date: Oct. 30, 2025

(54) RADAR SYSTEM AND RADAR RANGING METHOD

(71) Applicant: Rayz Technologies Co., Ltd., Beijing (CN)

(72) Inventors: Ruxin Chen, Beijing (CN); Detao Du, Beijing (CN)

(21) Appl. No.: 18/723,185

(22) PCT Filed: Dec. 22, 2022
(86) PCT No.: PCT/CN2022/140874

§ 371 Date: Nov. 13, 2024

(30) Foreign Application Priority Data
Dec. 22, 2021 (CN) 202111608050.4

(51) Int. Cl. G01S 7/4861; G01S 7/481; G01S 7/497; G01S 17/10

(52) U.S. Cl. CPC G01S 7/4861; G01S 7/4815; G01S 7/4816; G01S 7/4817; G01S 7/497; G01S 17/10

(57) ABSTRACT

A radar system and a radar ranging method. The radar system comprises: a light emission assembly (100), which successively emits a plurality of groups of emitted light; a receiving end assembly (200), which receives reflected light after the emission light is reflected by a target object and converts the reflected light into a received electrical signal; a light scanning member (300); and a processor (600), which determines the distance to the target object according to the received electrical signal, and adjusts control parameters related to the received electrical signal and a detection field-of-view angle, such that the control parameters change according to a first preset rule starting from an emission start moment; or the detection field-of-view angle changes according to a second preset rule starting from the emission start moment.

### CROSS-REFERENCE TO RELATED APPLICATIONS

The present patent application claims priority to Chinese Patent Application No. 202111608050.4, filed before the China National Intellectual Property Administration (CNIPA) on Dec. 22, 2021, which is hereby incorporated by reference in its entity.

### TECHNICAL FIELD

The present disclosure relates to the field of radar technology, and in particular, to a radar system and a radar ranging method.

### BACKGROUND

Radar is an electronic device that uses electromagnetic waves to detect target objects. Radar emits electromagnetic waves to target objects and receives their echoes, and after processing, it can obtain information such as distance, orientation and height of the target objects to the emission position where the electromagnetic waves are emitted.

A radar that uses a laser as its operating light beam is called lidar. When the hardware system of a lidar and atmospheric transmission conditions are determined, the energy of echoes decays rapidly as the distance between the lidar and a target object increases. In order to be able to extend the measuring range, the lidar needs to emit strong light, which may cause an overly strong echo signal from a short-distance target object, thus leading to severe saturation distortion of electrical signals after photoelectric conversion amplification.

### SUMMARY

Embodiments of the present disclosure relates to a radar system and a radar ranging method.

According to an embodiment of the present disclosure, the radar system may include: a light emission assembly, successively emitting a plurality of groups of emitted light; a receiving end assembly, receiving reflected light after the emitted light is reflected by a target object, and converting the reflected light into a received electrical signal; a light scanning member, successively deflecting, within a scanning duration of a present frame, the plurality of groups of emitted light emitted from the light emission assembly to irradiate to the target object, and/or deflecting the reflected light reflected from the target object to irradiate to the receiving end assembly; and a processor, determining a distance to the target object according to the received electrical signal, and adjusting control parameters related to the received electrical signal and a detection field-of-view, such that: the control parameters changes according to a first preset rule since an emission start moment at which the corresponding emitted light is emitted, and a change amount of a control parameter within a first preset duration is greater than a first preset change threshold; or, the detection field-of-view changes according to a second preset rule since the emission start moment at which the corresponding emitted light is emitted, and the change amount of the detection field-of-view within the first preset duration is greater than a second preset change threshold; where, the first preset duration is less than a maximal difference between the emission start moment and a reception moment, the reception moment being a moment at which the reflected light is received by the receiving end assembly.

According to an embodiment of the present disclosure, the radar ranging method may include: successively emitting a plurality of groups of emitted light; receiving the reflected light after the emitted light is reflected by the target object, and converting the reflected light into a received electrical signal; and successively deflecting, within the scanning duration of the present frame, the plurality of groups of emitted light to irradiate to a target object, and/or deflecting reflected light reflected from the target object to a receiving direction; determining a distance to the target object according to the received electrical signal, and adjusting control parameters related to the received electrical signal and a detection field-of-view, such that: the control parameters change according to a first preset rule since an emission start moment at which the corresponding emitted light is emitted, and a change amount of a control parameter within a first preset duration is greater than a first preset change threshold; or, the detection field-of-view changes according to a second preset rule since the emission start moment at which the corresponding emitted light is emitted, and the change amount of the detection field-of-view within the first preset duration is greater than a second preset change threshold; where, the first preset duration is less than a maximal difference between the emission start moment and a reception moment, the reception moment being a moment at which the reflected light is received.

In embodiments of the present disclosure, by adjusting the control parameters related to the received electrical signal or the detection field-of-view within the first preset duration according to actual needs, so that the control parameters change according to the first preset rule since the emission start moment, and a change amount within the first preset duration is greater than the first preset change threshold, or so that the detection field-of-view changes according to the second preset rule since the emission start moment, and the change amount within the first preset duration is greater than the second preset change threshold, the processor 600 can improve a dynamic range and precision of the distance measured by this radar system, that is, can improve measurement precision at a short-distance, and avoid saturation distortion of a short-distance reflected light beam after photoelectric conversion amplification, without affecting a long-distance detection capability.

It will be understood by those skilled in the art that the foregoing content of the present disclosure are merely illustrative and are not intended to be limiting in any way. In addition to the above illustrative aspects, embodiments and features, other aspects, embodiments and features will become apparent by referring to the accompanying drawings and the following detailed description.

### BRIEF DESCRIPTION OF THE DRAWINGS

Other features, objectives and advantages of the present disclosure will become more apparent by reading detailed descriptions of non-limiting embodiments made with reference to the following accompanying drawings.

FIG. 1 is a first block diagram of a radar system according to an embodiment of the present disclosure.

FIG. 2 is a second block diagram of the radar system according to an embodiment of the present disclosure.

FIG. 3 is a third block diagram of the radar system according to an embodiment of the present disclosure.

FIG. 4 is a schematic diagram of a control parameter changing over time according to an embodiment of the present disclosure.

FIG. 5 is a schematic diagram of a detection field-of-view changing over time according to an embodiment of the present disclosure.

FIG. 6 is a first schematic diagram of a dynamic bias voltage changing over time according to an embodiment of the present disclosure.

FIG. 7 is a second schematic diagram of a dynamic bias voltage changing over time according to an embodiment of the present disclosure.

FIG. 8 is a schematic diagram of an operation principle of a comparator according to an embodiment of the present disclosure.

FIG. 9 is a schematic diagram of a voltage value of a comparison input changing over time according to an embodiment of the present disclosure.

FIG. 10 is a schematic diagram of emitted light according to an embodiment of the present disclosure.

FIG. 11 is a schematic diagram of a relative size distribution of a pulse width of a received electrical signal corresponding to particular emitted light within a scanning duration of one preceding frame according to an embodiment of the present disclosure.

FIG. 12 is a first flowchart of a radar ranging method according to an embodiment of the present disclosure.

FIG. 13 is a second flowchart of the radar ranging method according to an embodiment of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. For ease of description, only the parts related to the invention, rather than the whole structure, are shown in the accompanying drawings.

Unless otherwise defined, all terms (including technical and scientific terms) used herein have the same meaning as commonly understood by those of ordinary skill in the art to which the present disclosure belongs. It will be further understood that terms, such as those defined in commonly used dictionaries, should be interpreted as having a meaning that is consistent with the meaning in the context of the relevant art and will not be interpreted in an idealized or overly formal sense, unless expressly so defined herein.

It should be noted that embodiments of the present disclosure and the features in the embodiments may be combined with each other on a non-conflict basis. In addition, unless expressly specified or contradicted by the context, the detailed operations contained in the methods described in embodiments of of the present disclosure need not be limited to the order described, but may be performed in any order or in parallel. Embodiments of the present disclosure will be described in detail below with reference to the accompanying drawings.

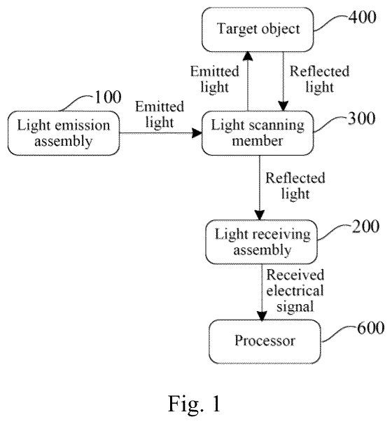

As shown in conjunction with FIGS. 1, 4, and 5, an embodiment of the present disclosure provides a radar system, the radar system including a light emission assembly 100, a receiving end assembly 200, a light scanning member 300, and a processor 600; where the light emission assembly 100 successively emits a plurality of groups of emitted light, the light scanning member 300 successively deflects, within the scanning duration of the present frame, the plurality of groups of emitted light emitted from the light emission assembly 100 to irradiate to a target object 400, and/or deflects reflected light reflected from the target object 400 to irradiate to the receiving end assembly 200, and the receiving end assembly 200 receives the reflected light after the emitted light is reflected by the target object 400 and converts the reflected light into a received electrical signal. Here, the processor 600 determines a distance to the target object 400 based on the received electrical signal, and adjusts a control parameter related to the received electrical signal and a detection field-of-view, such that: the control parameter changes according to a first preset rule since an emission start moment at which the corresponding emitted light is emitted, and the change amount of the control parameter within a first preset duration is greater than a first preset change threshold; or, the detection field-of-view changes according to a second preset rule since the emission start moment at which the corresponding emitted light is emitted, and the change amount of the detection field-of-view within the first preset duration is greater than a second preset change threshold; where, the first preset duration is less than a maximal difference between the emission start moment and a reception moment, the reception moment being a moment at which the reflected light is received by the receiving end assembly 200. As an example, the emitted light may be, but is not limited to, laser, infrared light, or ultraviolet light.

If the target object 400 is far away from the light emission assembly 100, then a duration costed for the emitted light emitted from the light emission assembly 100 to be irradiated to the target object 400 and then is reflected by the target object 400 to reach to the receiving end assembly 200 is long. Similarly, if the target object 400 is close to the light emission assembly 100, then the duration costed for the emitted light emitted from the light emission assembly 100 to be irradiated to the target object 400 and then is reflected by the target object 400 to reach to the receiving end assembly 200 is short. It can be seen that the duration may indicate the distance to the target object 400, i.e., if the receiving end assembly 200 receives the reflected light within the first preset duration starting from the emission start moment at which the emitted light is emitted, then it indicates that the target object 400 is close.

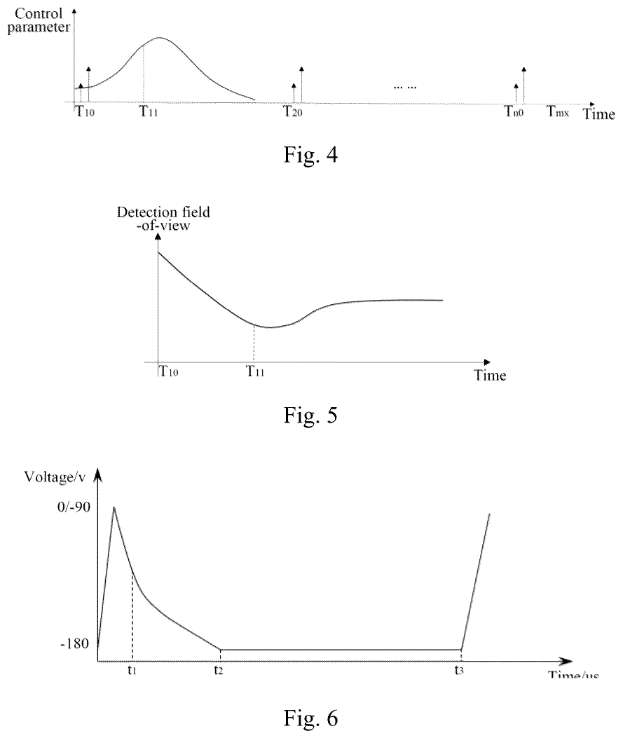

Based on this, as shown in FIGS. 4 and 5, at the moment T₁₀, i.e., the emission start moment, the 1st group of emitted light is emitted, at the moment T₂₀, the 2nd group of emitted light is emitted, and at the moment Tₙ₀, the nth group of emitted light is emitted. Here, T₁₁-T₁₀ is the first preset duration, T₂₀-T₁₀ is a time interval between two adjacent frame scans, and Tₘₓ-T₁₀ is the scanning duration of the present frame. Within the duration from T₁₀ to T₁₁, the control parameter changes according to the first preset rule, and the detection field-of-view changes according to the second preset rule. In embodiments of the present disclosure, by adjusting the control parameter or the detection field-of-view that is related to the received electrical signal within the first preset duration according to actual needs, so that the control parameter changes according to the first preset rule since the emission start moment, and the change amount within the first preset duration is greater than the first preset change threshold, or so that the detection field-of-view changes according to the second preset rule since the emission start moment, and the change amount within the first preset duration is greater than the second preset change threshold, the processor 600 can improve a dynamic range and precision of the distance measured by this radar system, that is, can improve measurement precision at a short distance, and avoid saturation distortion of a short-distance reflected light beam after photoelectric conversion amplification, without affecting a long-distance detection capability.

In the case of a radar system for long-distance ranging, for example, the detection field-of-view starts to change according to the second preset rule, i.e., an overall decreasing trend, since the emission start moment (i.e., the moment T₁₀) of the emission of the corresponding emitted light. That is, the processor 600 controls the light emission assembly 100 to operate at a large detection field-of-view within the first preset duration to enable the radar system to detect a larger scene, and then to operate at a small detection field-of-view to enable the radar system to detect a longer distance. Here, the size of the detection field-of-view may be changed by adjusting the light emission assembly 100, the receiving end assembly 200, or the light scanning member 300, etc. . . . For example, when the light scanning member 300 includes an optical phased array (hereinafter referred to as the OPA), the processor 600 may adjust the angle of the reflected light by controlling a parameter of the OPA, thus changing the detection field-of-view; when the light emission assembly 100 includes an array light source, the processor 600 may adjust the detection field-of-view by controlling the number and distribution positions of light emission units in the array light source; when the light emission assembly 100 includes an adjustable-focus lens assembly, the detection field-of-view may be adjusted by adjusting a focal length of the lens assembly.

In addition, it should be noted that the “control parameter related to the received electrical signal”, as the name implies, may be either a parameter in the radar system that affects a size of the received electrical signal or a parameter that is affected by the received electrical signal, e.g., the control parameter may be, but is not limited to, a bias voltage or a voltage value of a comparison input.

As an example, the control parameter includes the bias voltage.

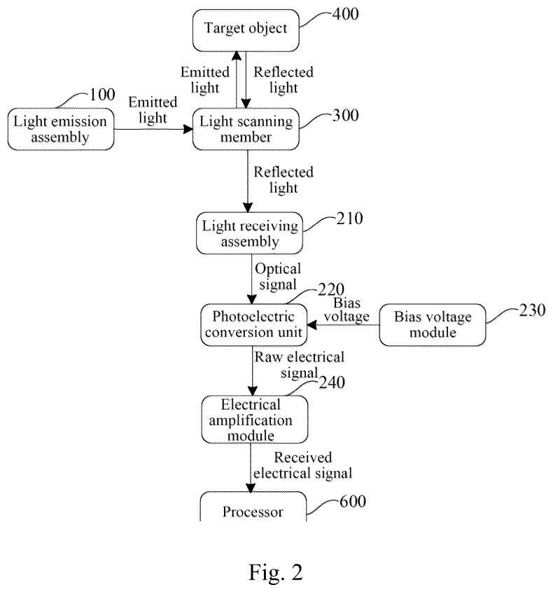

As shown in FIG. 2 and FIG. 6, the receiving end assembly 200 includes a light receiving assembly 210, a bias voltage module 230, a photoelectric conversion unit 220, and an electrical amplification module 240; where the light receiving assembly 210 receives the reflected light after the emitted light is reflected by the target object 400 and converts the reflected light into an optical signal, the bias voltage module 230 provides a dynamic bias voltage, the photoelectric conversion unit 220 converts the optical signal into a raw electrical signal based on the dynamic bias voltage, and the electrical amplification module 240 amplifies the raw electrical signal to obtain the received electrical signal. Here, the control parameter includes the dynamic bias voltage. An absolute value of the dynamic bias voltage changes to a first predetermined threshold according to the first preset rule within the first preset duration since the emission start moment, and remains not less than the first predetermined threshold for a second preset duration, and the absolute value of the dynamic bias voltage is less than the first predetermined threshold within the first preset duration. Here, the first predetermined threshold is an absolute value of a dynamic final bias voltage. Here, the photoelectric conversion unit 220 includes a photoelectric converter.

If the target object 400 is far away from the light emission assembly 100, then the duration costed for the emitted light emitted from the light emission assembly 100 to be irradiated to the target object 400 and the duration costed for the emitted light reflected by the target object 400 to reach the light receiving assembly 210 are both long. Thus, light intensity of the reflected light received by the light receiving assembly 210 is significantly attenuated, compared to the emitted light emitted from the light emission assembly 100. Since the absolute value of the dynamic bias voltage changes to the first predetermined threshold within the first preset duration since the emission start moment and remains not less than the first predetermined threshold for the second preset duration, and it can be known from the above description that it takes a long time for the emitted light to be reflected back from target object 400 at a long distance, the absolute value of the dynamic bias voltage corresponding to the moment at which the light receiving assembly 210 receives the reflected light is not less than the first predetermined threshold, so that the photoelectric conversion unit 220 may convert a weak optical signal into a strong raw electrical signal based on this dynamic bias voltage.

Similarly, if the target object 400 is close to the light emission assembly 100, then the duration costed for the emitted light emitted from the light emission assembly 100 to be irradiated to the target object 400 and the duration costed for the emitted light reflected by the target object 400 to reach the light receiving assembly 210 are both short. Thus, the light intensity of the reflected light received by the light receiving assembly 210 is less attenuated compared to the emitted light emitted from the light emission assembly 100. Since the absolute value of the dynamic bias voltage is less than the first predetermined threshold within the first preset duration since the emission start moment, and it can be known from the above description that it takes a short time for the emitted light to be reflected back from a target object 400 at a short distance, the absolute value of the dynamic bias voltage corresponding to the moment at which the light receiving assembly 210 receives the reflected light is less than the first predetermined threshold, so that the photoelectric conversion unit 220 may convert a strong optical signal into a relatively weak raw electrical signal based on this dynamic bias voltage, to avoid saturation distortion of strong optical signals after photoelectric conversion amplification.

As can be seen from the above, based on the principle that the intensity of a light beam in the process of propagation attenuates with the increase of propagation distance or propagation time, the radar system in embodiments of the present disclosure may, by using the dynamic bias voltage that changes over time, in the process of photoelectric conversion, make the reflected light reflected back from the target object 400 at a long distance correspond to a dynamic bias voltage with a larger absolute value, i.e., the absolute value of the dynamic bias voltage is not less than the first predetermined threshold, and make the reflected light reflected back from the target object 400 at a short distance correspond to a dynamic bias voltage with a smaller absolute value, i.e., the absolute value of the dynamic bias voltage is less than the first predetermined threshold, so as to not only improve the short-distance measurement precision, avoid the saturation distortion of a short-distance reflected light beam after photoelectric conversion amplification, but also not to affect the long-distance detection capability.

The radar system in embodiments of the present disclosure is described below using the example of the bias voltage module 230 providing a negative dynamic bias voltage, i.e., a dynamic bias voltage being less than zero.

As an example, when the dynamic bias voltage is less than zero, the first preset rule may be, but is not limited to, an overall decreasing trend of the dynamic bias voltage over time, that is, an overall increasing trend of the absolute value of the dynamic bias voltage within the first preset duration. For example, as shown in FIG. 6, the dynamic bias voltage has a nonlinearly and monotonically decreasing trend from the moment t₁ to the moment t₂, decreases to the dynamic final bias voltage, i.e., −180v, at the moment t₂, and remains stabilized and unchanged at the dynamic final bias voltage from the moment t₂ to the moment t₃. Here, the moment t₁ is the emission start moment, t₂-t₁ is the first preset duration, t₃-t₂ is the second preset duration, and the first predetermined threshold is the absolute value of the dynamic final bias voltage. It should be noted that the first preset duration and/or the second preset duration may be determined based on factors such as the intensity of the emitted light, environmental conditions such as atmospheric transmission conditions. For example, the first preset duration is less than 1 us, and the second preset duration is 1 us. If the target object 400 is close to the light emission assembly 100, then the duration costed for the emitted light to be irradiated to the target object 400 and the duration costed for the emitted light reflected by the target object 400 to reach the light receiving assembly are both short, so that the moment at which the light receiving assembly receives the reflected light, i.e., the moment t′ (not shown in the figure), is earlier than the moment t₂. The dynamic bias voltage provided by the bias voltage module 230 at the moment t′ is greater than −180V, that is, the absolute value of the dynamic bias voltage at the moment t′ is less than the first predetermined threshold, i.e., less than 180V, so that the photoelectric conversion unit 220 may convert, based on the dynamic bias voltage at the moment t′, a strong optical signal into a relatively weak raw electrical signal, avoiding the saturation distortion of strong optical signals after photoelectric conversion amplification. Similarly, if the target object 400 is far away from the light emission assembly 100, then the duration costed for the emitted light to be irradiated to the target object 400 and the duration costed for the emitted light reflected by the target object 400 to reach the light receiving assembly are both long, so that the moment at which the light receiving assembly receives the reflected light, i.e., the moment t″ (not shown in the figure), is later than the moment t₂. The dynamic bias voltage provided by the bias voltage module 230 at the moment t″ is −180V, that is, the absolute value of the dynamic bias voltage at the moment t″ is equal to the first predetermined threshold, i.e., 180V, so that the photoelectric conversion unit 220 may convert, based on the dynamic bias voltage at the moment t″, a weak optical signal into a strong raw electrical signal.

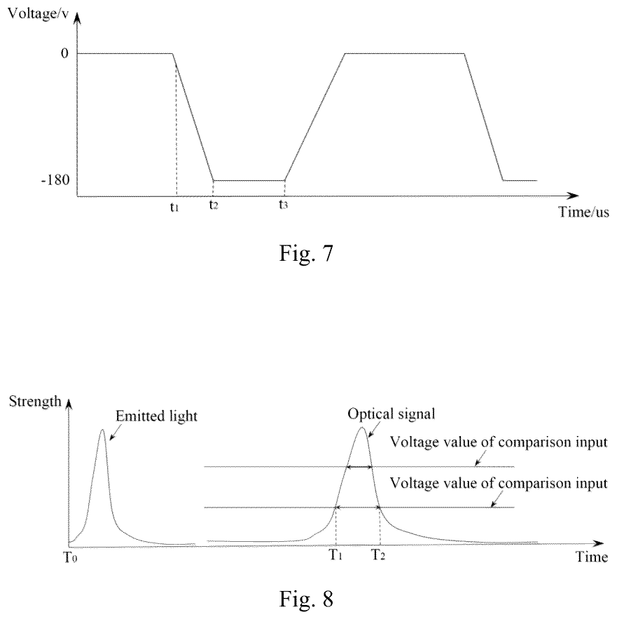

Of course, the dynamic bias voltage may, in addition to decreasing nonlinearly and monotonically from the moment t₁ to the moment t₂, decrease linearly and monotonically, or in an overall decreasing trend in a sinusoidal-like form, or in an overall decreasing trend in a square-wave-like form, as shown in FIG. 7. In addition, the absolute value of the dynamic bias voltage may either be stabilized at the first predetermined threshold from the moment t₂ to the moment t₃, or may gradually increase to be greater than the first predetermined threshold.

In order to be able to detect a plurality of target objects 400 simultaneously, the light emission assembly 100 includes a plurality of light emission units, the plurality of light emission units may successively emit a plurality of groups of emitted light to the corresponding target objects 400 respectively; and the receiving end assembly 200 includes the light receiving assembly 210 corresponding to the light emission units, the bias voltage module 230 and the photoelectric conversion unit 220. In addition, the light emission assembly 100 or the light receiving assembly 210 includes a lens.

As an example, the light emission units may, but is not limited to, include any one of a point light source, a line light source, and a surface light source, and the light scanning member 300 may, but is not limited to, include at least one of a MEMS mirror, a rotating prism, a rotating wedge prism, an optical phased array, an opto-electronic deflection device, or a liquid crystal reflector. The radar system also includes a bias power supply for powering the bias voltage module 230.

The light receiving assembly 210 may receive the reflected light reflected from the target object 400 using a direct method or an indirect method. In the indirect method, i.e., a coaxial light path method, as shown in FIG. 2, the light scanning member 300 is provided on the emitted light path of the light emission unit and the reflected light path of the target object 400. In this case, the emitted light generated by the light emission unit is first irradiated to the light scanning member 300, then deflected by the light scanning member 300 and irradiated to the target object 400 at a preset angle, and the emitted light is reflected by the target object 400 and then irradiated back to the light scanning member 300, and finally deflected by the light scanning member 300 and irradiated to the light receiving assembly 210. In the direct method, i.e., a non-coaxial light path method, the light receiving assembly 210 is provided on the reflected light path of the target object 400. In this case, the emitted light generated by the light emission unit is first irradiated to the light scanning member 300, then deflected by the light scanning member 300 and irradiated to the target object 400 at the preset angle, and the emitted light is reflected by the target object 400 and then directly irradiated to the light receiving assembly 210. Similarly, the emitted light may also be directly irradiated to the target object 400 without being deflected by the light scanning member 300.

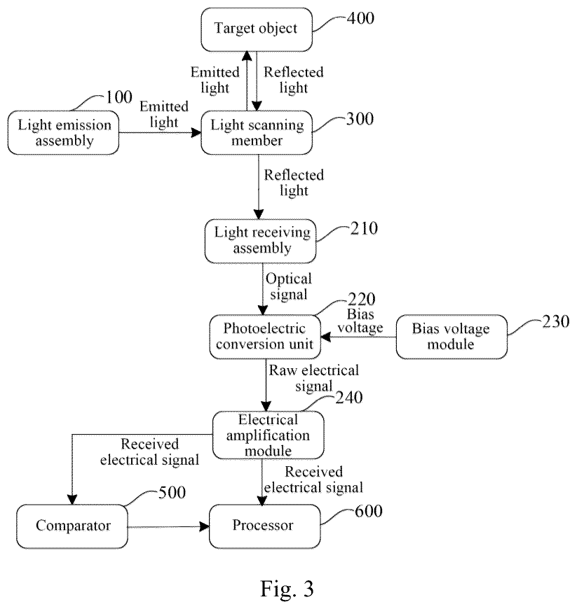

As shown in FIG. 3, the radar system further includes a comparator 500, the comparator 500 receives a comparison input and compares the received electrical signal with a voltage value of the comparison input, to determine a trigger start moment since which a strength of the received electrical signal is higher than the voltage value of the comparison input; where, the processor 600 is configured to calculate an initial measurement distance to the target object 400 based on the emission start moment and the trigger start moment.

Taking the comparison input in FIG. 8 with a small voltage value as an example, the moment T0 is the emission start moment, and the comparator 500 compares the received electrical signal with the voltage value of the comparison input. The comparator 500 is triggered by a start moment since which the strength of the received electrical signal is higher than the voltage value of the comparison input, and the comparator 500 determines the trigger start moment T1 based on this. Of course, the comparator 500 is also triggered by an end moment, that of the strength of the received electrical signal being higher than the voltage value of the comparison input ends at the end moment, and the comparator 500 determines a trigger end moment T2 based on this. The processor 600 may obtain a time-of-flight duration for the light beam by finding a difference between the trigger start moment T1 and the emission start moment T0, and then may obtain the initial measurement distance based on the time-of-flight duration and the speed of light.

On this basis, the processor 600 may further correct the initial measurement distance according to a preset error correction function, to determine a fine measurement distance between the light emission assembly 100 and the target object 400.

In some embodiments, the processor 600 is communicatively connected to the photoelectric conversion unit 220, and the processor 600 is further configured to determine a signal strength of the received electrical signal; the comparator 500 determines a pulse width based on the trigger start moment T1 and the trigger end moment T2. The pulse width is a difference between the trigger end moment T2 and the trigger start moment T1; and the error correction function is determined on basis of at least one of the initial measurement distance, the pulse width, or the signal strength.

For example, the processor 600 includes an analogue-to-digital converter (ADC) and/or a TDC, the ADC is used for determining the signal strength of the received electrical signal, and the TDC is used for calculating the time-of-flight duration for the light beam by using the trigger start moment T1 and the emission start moment T0. The processor 600 may be, but is not limited to, a mainboard.

As an example, the error correction function includes a polynomial with at least one of the initial measurement distance, the pulse width, or the signal strength as an independent variable. For example, the error correction function includes a primary polynomial and/or a cubic polynomial. The primary polynomial is a function with the initial measurement distance as one of the independent variables and with the pulse width or the signal strength as the other independent variable, for example z₁(x,y)=−11.43+37.47*(x−0.1)+1.062*y; where, z₁(x,y) represents the error correction function, x represents the initial measurement distance, and y represents the pulse width or the signal strength. The cubic polynomial is a function using the pulse width or the signal strength as the independent variable, for example z₂(y)=−0.0182*y³+0.8412*y²−12.705*y+66.386; where, z₂(y) represents the error correction function, and y represents the pulse width or the signal strength.

Considering that the light intensity of the refection light reflected from a target object 400

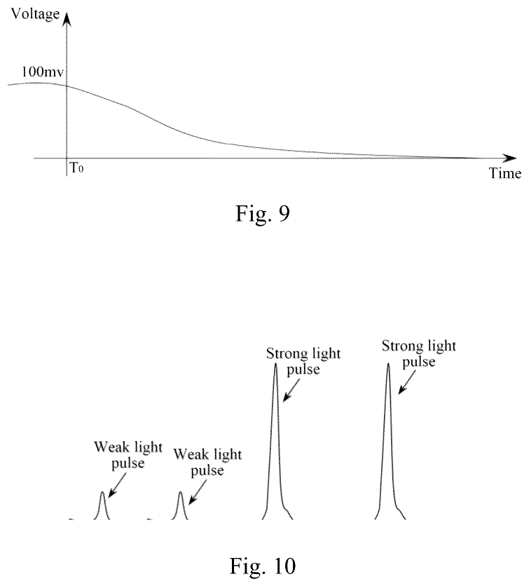

at a short distance is strong, and the light intensity of the refection light reflected from a target object 400 at a long distance is weak, in the case where the voltage value of the comparison input is a fixed value, if the voltage value of the comparison input is small, the received electrical signal converted from the short-distance refection light may cause the comparator 500 to generate noise or saturation; and if the voltage value of the comparison input is large, the voltage value of the comparison input may be larger than the received electrical signal converted from the long-distance refection light and cannot be triggered. Therefore, in order to avoid the above situations, as shown in FIG. 9, the voltage value of the comparison input in embodiments of the present disclosure changes dynamically according to the first preset rule since the emission start moment, so as to improve a short-distance discrimination ability of the comparator 500, without affecting the long-distance detection capability.

The following is an example of the control parameter including the voltage value of the comparison input.

As an example, the first preset rule corresponding to the comparison input may be, but is not limited to, an overall decreasing trend in the voltage value of the comparison input over time, e.g., as shown in FIG. 9, the first preset rule is monotonically decreasing. If the target object 400 is close to the light emission assembly 100, then the duration for the emitted light emitted from the light emission assembly 100 reflected by the target object 400 to reach the light receiving assembly is short, so that the voltage value of the comparison input corresponding to the moment at which the received electrical signal is input into the comparator 500 is large, thus avoiding generating noise or saturation in the comparator 500. If the target object 400 is far away from the light emission assembly 100, then the duration for the emitted light emitted from the light emission assembly 100 reflected by the target object 400 to reach the light receiving assembly is long, so that the voltage value of the comparison input corresponding to the moment at which the received electrical signal is input into the comparator 500 is small, thus avoiding the situation where the voltage value of the comparison input is larger than the received electrical signal and cannot be triggered. It should be noted that, apart from the monotonically decreasing trend in the voltage value of the comparison input, the first preset rule corresponding to the comparison input may also be an overall decreasing trend in a sinusoidal-like form, or an overall decreasing trend in a square-wave-like form. Of course, the first preset rule corresponding to the comparison input may also be that the voltage value of the comparison input changes over time according to a sinusoidal rule or a square-wave rule, so as to improve the detection capability at local distances by distance segmentation. In addition, the first preset rule corresponding to the comparison input and the first preset rule corresponding to the dynamic bias voltage may be the same or different.

In some embodiments, an optical characteristic of the emitted light or the reflected light includes at least one of light intensity, an AM modulation function, i.e., an amount modulation function, an FM modulation function, i.e., a frequency modulation function, an optical waveform type, an optical polarizability, an optical wavelength, an optical wavelength distribution, a spot shape, or a light pulse temporal width.

As shown in FIG. 10, each group of emitted light includes at least one strong light pulse and/or at least one weak light pulse, and an emission parameter of the light emission assembly 100 is determined based on the pulse width of the received electrical signal or the strength of the received electrical signal corresponding to particular emitted light within scanning duration(s) of previous N frame(s). Here, N is a positive integer, and the particular emitted light is emitted light within the scanning duration(s) of the previous N frame(s) and has an emission direction which deviates from a current emission direction of the emitted light by an angle less than a preset angle; and the emission parameter includes at least one of: the numbers of the strong light pulse and the weak light pulse, an optical characteristic, or an emission order of the strong light pulse and the weak light pulse. Here, the preset angle may be, but is not limited to, 1.1°; and the optical characteristic includes at least one of an optical waveform type, an optical polarizability, an optical wavelength, an optical wavelength distribution, a spot shape, or a light pulse temporal width.

In particular, the light emission assembly 100 is configured to: emit emitted light including at least one weak light pulse and at least one strong light pulse, based on that the pulse width of all the received electrical signal or the strength of all the received electrical signal corresponding to the particular emitted light within the scanning duration(s) of the previous N frame(s) is greater than a preset light intensity threshold; where, an emission moment of the weak light pulse is earlier than an emission moment of the strong light pulse; or, emit emitted light including a plurality of strong light pulses, based on that the pulse width of at least one of the received electrical signal or the strength of at least one of the received electrical signal corresponding to the particular emitted light within the scanning duration(s) of the previous N frame(s) is not greater than the preset light intensity threshold.

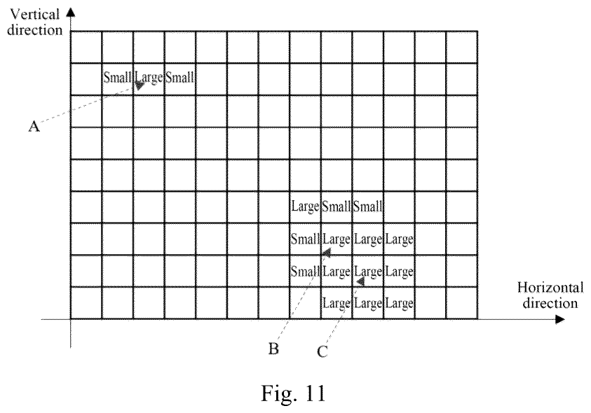

As shown in FIG. 11, N=1, taking point A as an example, the pulse widths of the received electrical signals or the intensities of the received electrical signals corresponding to two beams of particular emitted light adjacent to point A within the scanning duration of the previous frame are not greater than the preset light intensity threshold, therefore, the emitted light emitted by the light emission assembly 100 to point A within the scanning duration of the present frame includes at least two strong light pulses. Similarly, taking point B as an example, the pulse widths of the received electrical signals or the intensities of the received electrical signals corresponding to eight beams of particular emitted light adjacent to point B within the scanning duration of the previous frame are not all greater than the preset light intensity threshold, therefore, the emitted light emitted by the light emission assembly 100 to point B within the scanning duration of the present frame also includes at least two strong light pulses. Taking point C as an example, the pulse widths of the received electrical signals or the intensities of the received electrical signals corresponding to eight beams of particular emitted light adjacent to point C within the scanning durations of the previous frame are all greater than the preset light intensity threshold, therefore, the emitted light emitted by the light emission assembly 100 to point C within the scanning duration of the present frame also includes at least one weak light pulse and at least one strong light pulse, and the emission moment of the weak light pulse is earlier than the emission moment of the strong light pulse.

The advantage of such setting is that, on the one hand, since the light emission assembly 100 successively and continuously emits a plurality of beams of light (i.e., strong light pulses and/or weak light pulses) each time within a certain duration (e.g., 0.1 us), and the temporal interval between beams of light is determined, it is very easy to distinguish the reflected light formed by the emitted light after reflected by the target object 400 from external stray light, thereby avoiding stray light interference from the external environment. On the other hand, the distance between the light emission assembly 100 and the target object 400 directly affects the intensity of the reflected light, in the case where the intensity of the emitted light and external environmental factors such as atmospheric transmission conditions are determined, the further the distance between the light emission assembly 100 and the target object 400, the lower the intensity of the reflected light. Thus, when the pulse width of at least one of the received electrical signal or the strength of at least one of the received electrical signal corresponding to the particular emitted light within the scanning duration(s) of the previous N frame(s) is not greater than the preset light intensity threshold, it indicates that the distance between the light emission assembly 100 and the target object 400 is far, and the light emission assembly 100 successively emits a plurality of strong light pulses each time, then the electrical amplification module 240 can output a plurality of received electrical signals corresponding to the strong light pulses, and the comparator 500 may compare the voltage value of the comparison input with the plurality of received electrical signals to determine a plurality of pairs of trigger start moments and trigger end moments corresponding to the received electrical signals, and then the processor 600 may calculate to obtain a plurality of initial measurement distances corresponding to the received electrical signals based on the plurality of emission start moments and trigger start moments. In addition, it should be noted that when the emitted light includes weak light pulses, the radar system is more easily able to detect an electro-optical power of an object at close distance while reducing the saturation distortion caused by emitted signals. On the basis of the above, the processor 600 may then calculate corresponding fine measurement distances based on the plurality of initial measurement distances, and then average the plurality of fine measurement distances to obtain an actual average distance.

Of course, in order to improve the ranging accuracy, in addition to adjusting the emission parameter of the emitted light within the scanning duration of the present frame, it is also possible to directly emit emitted light including both weak light pulse and strong light pulse each time, and calculate the fine measurement distance by selecting the appropriate initial measurement distance.

In particular, in the case where the emitted light includes at least one weak light pulse and at least one strong light pulse, the processor 600 may select the initial measurement distance in the following manners. If the initial measurement distances are all less than a preset distance, it indicates that the target object 400 is close to the light emission assembly 100. In this case, the processor 600 then corrects the initial measurement distance corresponding to the weak light pulse according to the error correction function to determine the fine measurement distance. If at least one of the initial measurement distances is not less than the preset distance, it indicates that the target object 400 is far away from the light emission assembly 100. In this case, the processor 600 then corrects the initial measurement distance corresponding to the strong light pulse according to the error correction function to determine the fine measurement distance. As can be seen, the processor 600 calculates the fine measurement distance by selecting the corresponding initial measurement distance based on the distance to the target object 400, i.e., by using the initial measurement distance corresponding to the weak light pulse to calculate the fine measurement distance to a target object 400 at a short distance, and by using the initial measurement distance corresponding to the strong light pulse to calculate the fine measurement distance to a target object 400 at a long distance, which may improve the accuracy of short-distance calculation results, without affecting the long-distance detection capability.

In the case where the light emission assembly 100 successively emits a plurality of beams of light each time, the processor 600 calculates a plurality of fine measurement distances for the same target object 400, and in order to improve the ranging accuracy of the radar system, the processor 600 averages the plurality of fine measurement distances to obtain the actual average distance. For example, as shown in FIG. 9, the light emission assembly 100 first successively and continuously emits two weak light pulses within 10 ns˜ns each time, and then successively and continuously emits two strong light pulses. If the target object 400 is close to the light emission assembly 100, then the processor 600 respectively corrects the initial measurement distances corresponding to the two weak light pulses by using the error correction function and then finds an average of the corrected initial measurement distances. As an example, a ratio of the intensity of the weak light pulse to the intensity of the strong light pulse is greater than a preset ratio; where the preset ratio is any one of 1:2, 1:4, 1:10 or 1:100. As an example, the strong light pulse and/or the weak light pulse has a pulse width of 0.1 ns to 10 ns. As an example, the weak light pulse and the strong light pulse have different optical characteristics; where, the optical characteristics include at least one of an optical waveform type, an optical polarizability, an optical wavelength, an optical wavelength distribution, a spot shape, or a light pulse temporal width.

It should be noted that in the case where the emitted light includes a plurality of beams of light, for example, where the emitted light includes at least one weak light pulse and at least one strong light pulse, or where the emitted light includes a plurality of strong light pulses, the photoelectric conversion unit 220 outputs a plurality of received electrical signals, and the received electrical signals may either be matched to the same comparison input or be matched to different comparison inputs. For example, the number of the comparison inputs is equal to the number of the received electrical signals, and the comparison inputs correspond one-to-one with the received electrical signals. For example, the number of the comparison inputs is less than the number of the received electrical signals, and at least some of the received electrical signals correspond to the same comparison input. For example, the number of the comparison inputs is greater than the number of the received electrical signals, and at least one of the received electrical signals corresponds to a plurality of comparison inputs.

In some embodiments, in the case where the receiving end assembly 200 includes the electrical amplification module 240, the electrical amplification module 240 including sequentially electrically connected amplifiers of multi-stages; where, a strength of an electrical signal output by an upper-stage amplifier in amplifiers of two adjacent stages is less than a strength of an electrical signal output by a lower-stage amplifier in the amplifiers of the two adjacent stages, and a voltage value of the comparison input corresponding to an electrical signal output by each stage amplifier is different from each other. For example, the electrical amplification module 240 includes a first-stage amplifier and a second-stage amplifier; where, the strength of the electrical signal output by the first-stage amplifier is less than the strength of the electrical signal output by the second-stage amplifier, the second-stage amplifier amplifies the electrical signal output by the first-stage amplifier, and the voltage value of the comparison input corresponding to the first-stage amplifier is not the same as the voltage value of the comparison input corresponding to the second-stage amplifier.

In addition, the processor 600 is configured to determine an angle at which the emitted light irradiates to the target object 400 based on a scanning angle of the light scanning member 300 and the received electrical signal.

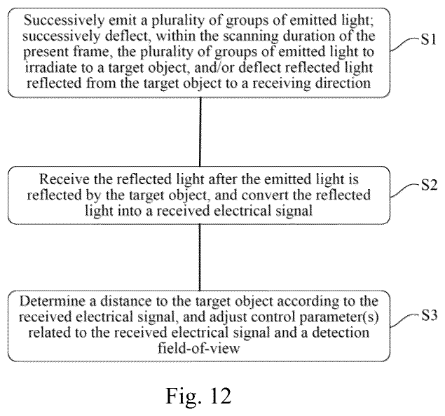

As shown in FIG. 12, an embodiment of the present disclosure also provides a radar ranging method. The method includes following operations.

S1, successively emitting a plurality of groups of emitted light; successively deflecting, within a canning duration of the present frame s, the plurality of groups of emitted light to irradiate to a target object 400, and/or deflecting reflected light reflected from the target object 400 to a receiving direction.

S2, receiving the reflected light after the emitted light is reflected by the target object 400, and converting the reflected light into a received electrical signal.

S3, determining a distance to the target object 400 according to the received electrical signal, and adjusting control parameter(s) related to the received electrical signal and a detection field-of-view, such that: the control parameter(s) changes according to a first preset rule since an emission start moment at which the corresponding emitted light is emitted, and the change amount of a control parameter within a first preset duration is greater than a first preset change threshold. It should be noted that the “control parameter related to the received electrical signal”, as the name implies, may be either a parameter in the radar system that affects a size of the received electrical signal or a parameter that is affected by the received electrical signal, e.g., the control parameter may be, but is not limited to, a bias voltage or a voltage value of a comparison input. Or, adjusting control parameter(s) related to the received electrical signal and a detection field-of-view, such that: the detection field-of-view changes according to a second preset rule since the emission start moment at which the corresponding emitted light is emitted, and the change amount of the detection field-of-view within the first preset duration is greater than a second preset change threshold; where, the first preset duration is less than a maximal difference between the emission start moment and a reception moment, the reception moment being a moment at which the reflected light is received.

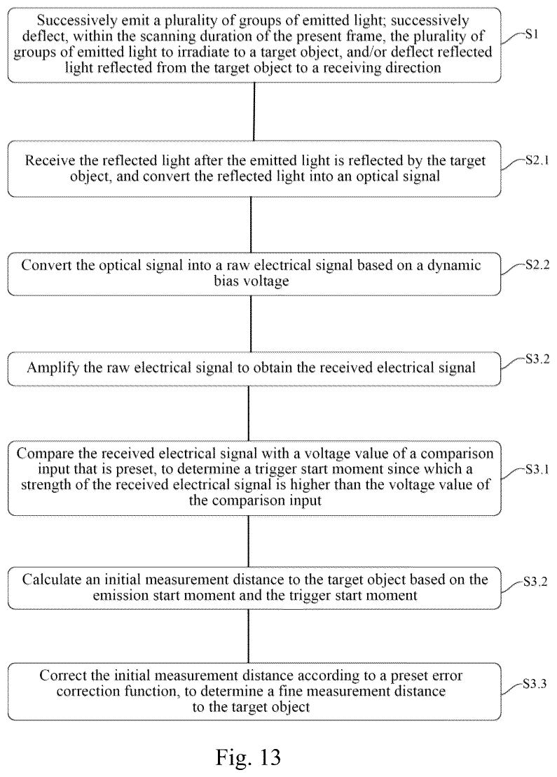

As shown in FIG. 13, in some embodiments, S2 includes following operations.

S2.1, receiving the reflected light after the emitted light is reflected by the target object 400 and converting the reflected light into an optical signal.

S2.2, converting the optical signal into a raw electrical signal based on a dynamic bias voltage.

S2.3, amplifying the raw electrical signal to obtain the received electrical signal.

The control parameter includes the dynamic bias voltage, where an absolute value of the dynamic bias voltage changes to a first predetermined threshold according to the first preset rule within the first preset duration since the emission start moment and remains not less than the first predetermined threshold for a second preset duration, and the absolute value of the dynamic bias voltage is less than the first predetermined threshold within the first preset duration.

In some embodiments, the determining a distance to the target object 400 according to the received electrical signal in S3 includes the following operations.

S3.1, comparing the received electrical signal with a voltage value of a comparison input that is preset, to determine a trigger start moment since which a strength of the received electrical signal is higher than the voltage value of the comparison input.

S3.2, calculating an initial measurement distance to the target object 400 based on the emission start moment and the trigger start moment.

After the above step S3.2 is performed, the following operations are also included.

S3.3, correcting the initial measurement distance based on a preset error correction function, to determine a fine measurement distance to the target object 400.

In order to determine the error correction function, the radar ranging method further includes the following steps: determining a trigger end moment before which the strength of the received electrical signal is higher than the voltage value of the comparison input, and determining a pulse width based on the trigger start moment and the trigger end moment. Here, the error correction function is determined on basis of at least one of the initial measurement distance, the pulse width or the signal strength.

In order to improve a short-distance discrimination ability of the comparator 500, without affecting the long-distance detection capability, the voltage value of the comparison input in embodiments of the present disclosure changes dynamically according to the first preset rule since the emission start moment, and the control parameter includes the voltage value of the comparison input.

In some embodiments, the emitted light includes at least one strong light pulse and/or at least one weak light pulse, and S1 includes the following operations.

S1.1, determining an emission parameter based on the pulse width of the received electrical signal or the strength of the received electrical signal corresponding to particular emitted light within a scanning duration(s) of previous N frame(s); where, N is a positive integer, and the particular emitted light is emitted light within the scanning duration(s) of the previous N frame(s) and has an emission direction which deviates from a current emission direction of the emitted light by an angle less than a preset angle; and the emission parameter including at least one of: the numbers of the strong light pulse and the weak light pulse, an optical characteristic, or an emission order of the strong light pulse and the weak light pulse.

S1.2, emitting the emitted light including at least one strong light pulse and/or at least one weak light pulse based on the emission parameter.

Further, S1.2 may include the following operations.
emitting emitted light including at least one weak light pulse and at least one strong light pulse, in response to the pulse width of all the received electrical signal or the strength of all the received electrical signal corresponding to the particular emitted light within the scanning duration(s) of the previous N frame(s) being greater than a preset light intensity threshold; where, an emission moment of the weak light pulse is earlier than an emission moment of the strong light pulse;
or, emitting emitted light including a plurality of strong light pulses, in response to the pulse width of at least one of the received electrical signal or the strength of at least one of the received electrical signal corresponding to the particular emitted light within the scanning duration(s) of the previous N frame(s) being not greater than the preset light intensity threshold.

Here, the particular emitted light is emitted light within the scanning duration(s) of the previous N frame(s) and has an emission direction which deviates from a current emission direction of the emitted light by an angle less than a preset angle.

In the case where the emitted light includes at least one weak light pulse and at least one strong light pulse, steps of the determining a fine measurement distance to the target object 400 in S3.3 includes: based on that all of the initial measurement distance is less than a preset distance, correcting the initial measurement distance corresponding to the weak light pulse according to the error correction function, to determine the fine measurement distance; or, based on that at least one of the initial measurement distance is not less than the preset distance, correcting the initial measurement distance corresponding to the strong light pulse according to the error correction function, to determine the fine measurement distance.

In the case where the light emission assembly 100 successively emits a plurality of beams of light each time, the processor 600 calculates a plurality of fine measurement distances for the same target object 400, and in order to improve the ranging accuracy of the radar system, steps of the determining a fine measurement distance to the target object 400 in step S3.3 further include: in response to a plurality of fine measurement distances corresponding to the weak light pulse or the strong light pulse being determined, averaging the plurality of the fine measurement distances to obtain an actual average distance.

The foregoing is only a description of embodiments of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present disclosure with (but not limited to) technical features with similar functions.

1. A radar system, comprising:
a light emission assembly, configured to: successively emit a plurality of groups of emitted light;
a receiving end assembly, configured to: receive reflected light after the emitted light is reflected by a target object, and convert the reflected light into a received electrical signal;
a light scanning member, configured to: successively deflect, within a scanning duration of a present frame, the plurality of groups of emitted light emitted from the light emission assembly to irradiate to the target object, and/or deflect the reflected light reflected from the target object to irradiate to the receiving end assembly; and
a processor, configured to: determine a distance to the target object according to the received electrical signal, and adjust control parameters related to the received electrical signal and a detection field-of-view, such that:
the control parameters change according to a first preset rule since an emission start moment at which the corresponding emitted light is emitted, and a change amount of a control parameter within a first preset duration is greater than a first preset change threshold; or
the detection field-of-view changes according to a second preset rule since the emission start moment at which the corresponding emitted light is emitted, and a change amount of the detection field-of-view within the first preset duration is greater than a second preset change threshold;
wherein, the first preset duration is less than a maximal difference between the emission start moment and a reception moment, the reception moment being a moment at which the reflected light is received by the receiving end assembly.

2. The radar system according to claim 1, wherein the control parameters comprise a dynamic bias voltage;
the receiving end assembly comprises:
a light receiving assembly, configured to: receive the reflected light after the emitted light is reflected by the target object, and convert the reflected light into an optical signal;
a bias voltage module, configured to: provide the dynamic bias voltage; wherein an absolute value of the dynamic bias voltage changes to a first predetermined threshold according to the first preset rule within the first preset duration since the emission start moment and remains not less than the first predetermined threshold for a second preset duration, and the absolute value of the dynamic bias voltage is less than the first predetermined threshold within the first preset duration; and
a photoelectric conversion unit, configured to: convert the optical signal into a raw electrical signal based on the dynamic bias voltage;
an electrical amplification module, configured to: amplify the raw electrical signal to obtain the received electrical signal.

3. The radar system according to claim 2, wherein the dynamic bias voltage is less than zero, and the first preset rule is an overall decreasing trend of the dynamic bias voltage over time.

4. (canceled)

5. (canceled)

6. The radar system according to claim 1, wherein the second preset rule is an overall decreasing trend of the detection field-of-view over time.

7. (canceled)

8. The radar system according to claim 1, wherein the radar system further comprises:
a comparator, configured to: receive a comparison input, and compare the received electrical signal with a voltage value of the comparison input, to determine a trigger start moment since which a strength of the received electrical signal is higher than the voltage value of the comparison input;
wherein, the processor is configured to calculate an initial measurement distance to the target object based on the emission start moment and the trigger start moment.

9. The radar system according to claim 8, wherein the control parameters comprise the voltage value of the comparison input, and the voltage value of the comparison input changes dynamically according to the first preset rule since the emission start moment.

10. The radar system according to claim 9, wherein the first preset rule corresponding to the comparison input is monotonically decreasing trend in the voltage value of the comparison input over time.

11. (canceled)

12. The radar system according to claim 8, wherein a number of the comparison input is equal to a number of the received electrical signal, and the comparison input corresponds one-to-one with the received electrical signal; or
a number of the comparison input is less than a number of the received electrical signal, and at least multiple received electrical signals correspond to the same comparison input; or
a number of the comparison input is greater than a number of the received electrical signal, and at least one received electrical signal corresponds to multiple comparison inputs.

13. (canceled)

14. (canceled)

15. The radar system according to claim 8, wherein the receiving end assembly comprises an electrical amplification module, the electrical amplification module comprising sequentially electrically connected amplifiers of multi-stages; wherein a strength of an electrical signal output by an upper-stage amplifier in amplifiers of two adjacent stages is less than a strength of an electrical signal output by a lower-stage amplifier in the amplifiers of the two adjacent stages, and a voltage value of the comparison input corresponding to an electrical signal output by each stage amplifier is different from each other.

16. The radar system according to claim 8, wherein the processor is configured to correct the initial measurement distance according to a preset error correction function, to determine a fine measurement distance to the target object.

17. The radar system according to claim 16, wherein the comparator is further configured to: determine a trigger end moment before which the strength of the received electrical signal is higher than the voltage value of the comparison input, and determine a pulse width based on the trigger start moment and the trigger end moment.

18. The radar system according to claim 17, wherein the processor is configured to determine a signal strength of the received electrical signal; and the error correction function is determined on basis of at least one of the initial measurement distance, the pulse width or the signal strength.

19. The radar system according to claim 17, wherein each group of the emitted light comprises at least one strong light pulse and/or at least one weak light pulse.

20. The radar system according to claim 19, wherein an emission parameter of the light emission assembly is determined based on the pulse width of the received electrical signal or the strength of the received electrical signal corresponding to particular emitted light within scanning duration of previous N frame;
wherein, N is a positive integer, and the particular emitted light is emitted light within the scanning duration of the previous N frame and has an emission direction which deviates from a current emission direction of the emitted light by an angle less than a preset angle; and the emission parameter comprising at least one of: numbers of the strong light pulse and the weak light pulse, an optical characteristic, or an emission order of the strong light pulse and the weak light pulse.

21. The radar system according to claim 20, wherein the light emission assembly is configured to:
emit emitted light comprising at least one weak light pulse and at least one strong light pulse, based on that the pulse width of all the received electrical signal or the strength of all the received electrical signal corresponding to the particular emitted light within the scanning duration of the previous N frame is greater than a preset light intensity threshold; wherein, an emission moment of the weak light pulse is earlier than an emission moment of the strong light pulse; or,
emit emitted light comprising a plurality of strong light pulses, based on that the pulse width of at least one of the received electrical signal or the strength of at least one of the received electrical signal corresponding to the particular emitted light within the scanning duration of the previous N frame is not greater than the preset light intensity threshold.

22. The radar system according to claim 20, wherein the processor is configured to:
based on that all of the initial measurement distance is less than a preset distance, correct the initial measurement distance corresponding to the weak light pulse according to the error correction function, to determine the fine measurement distance; or,
based on that at least one of the initial measurement distance is not less than the preset distance, correct the initial measurement distance corresponding to the strong light pulse according to the error correction function, to determine the fine measurement distance.

23. The radar system according to claim 22, wherein, the processor is further configured to; in response to a plurality of fine measurement distances corresponding to the weak light pulse or the strong light pulse being determined, average the plurality of fine measurement distances to obtain an actual average distance.

24. The radar system according to claim 19, wherein a ratio of an intensity of the weak light pulse to an intensity of the strong light pulse is greater than a preset ratio; wherein the preset ratio is any one of 1:2, 1:4, 1:10 or 1:100.

25. (canceled)

26. A radar ranging method, comprising steps as follows:
successively emitting a plurality of groups of emitted light;
successively deflecting, within a scanning duration of a present frame, the plurality of groups of emitted light to irradiate to a target object, and/or deflecting reflected light reflected from the target object to a receiving direction;
receiving the reflected light after the emitted light is reflected by the target object, and converting the reflected light into a received electrical signal;
determining a distance to the target object according to the received electrical signal, and adjusting control parameters related to the received electrical signal and a detection field-of-view, such that:
the control parameters change according to a first preset rule since an emission start moment at which the corresponding emitted light is emitted, and a change amount of a control parameter within a first preset duration is greater than a first preset change threshold; or
the detection field-of-view changes according to a second preset rule since the emission start moment at which the corresponding emitted light is emitted, and a change amount of the detection field-of-view within the first preset duration is greater than a second preset change threshold;
wherein, the first preset duration is less than a maximal difference between the emission start moment and a reception moment, the reception moment being a moment at which the reflected light is received.

27. The radar ranging method according to claim 26, wherein the receiving the reflected light after the emitted light is reflected by the target object, and converting the reflected light into a received electrical signal comprises:
receiving the reflected light after the emitted light is reflected by the target object and converting the reflected light into an optical signal; and
converting the optical signal into a raw electrical signal based on a dynamic bias voltage;
amplifying the raw electrical signal to obtain the received electrical signal;
wherein, the control parameters comprise the dynamic bias voltage, where an absolute value of the dynamic bias voltage changes to a first predetermined threshold according to the first preset rule within the first preset duration since the emission start moment and remains not less than the first predetermined threshold for a second preset duration, and the absolute value of the dynamic bias voltage is less than the first predetermined threshold within the first preset duration.

28. (canceled)

29. (canceled)

30. (canceled)

31. (canceled)

32. (canceled)

33. (canceled)

34. (canceled)

35. (canceled)

36. (canceled)
